(19) United States
(12) Patent Application Publication
(10) Pub. No.: US 2011/0014516 A1
(43) Pub. Date: Jan. 20, 2011

(54) RECHARGEABLE BATTERY

(75) Inventors: Sae-Weon ROH, Suwon-si (KR); Tae-Keun KIM, Suwon-si (KR); Jun-Sik KIM, Suwon-si (KR); Man-Seok HAN, Suwon-si (KR); Nam-Soon CHOI, Suwon-si (KR); Jin-Kyu HONG, Suwon-si (KR); Jae-Min YANG, Suwon-si (KR); Sung-Soo KIM, Suwon-si (KR)

Correspondence Address: ROBERT E. BUSHNELL & LAW FIRM, 2029 K STREET NW, SUITE 600, WASHINGTON, DC, 20006-1004, US

(73) Assignee: SAMSUNG SDI CO., LTD., Suwon-si (KR)

(21) Appl. No.: 12/757,170

(22) Filed: Apr. 9, 2010

(30) Foreign Application Priority Data
Jul. 14, 2009 (KR) 10-2009-0064196

(51) Int. Cl. H01M 2/08

(52) U.S. Cl. 429/185

(57) ABSTRACT

A rechargeable battery that includes a case made of a laminate sheet; an electrode assembly installed in the case and an electrode terminal that protrudes outside the case and is connected to the electrode assembly. The case includes a receiving unit receiving the electrode assembly and including a first sealing part, and a cover covering the receiving unit and including a second sealing part that is thermally fused to the first sealing part. The first sealing part and the second sealing part include first protrusions and depressions and second protrusions and depressions respectively formed on a portion corresponding at least to the electrode terminal, and the electrode terminal includes third protrusions and depressions respectively corresponding to the first protrusions and depressions and the second protrusions and depressions.

### CLAIM OF PRIORITY

This application claims the benefit of Korean Patent Application No. 10-2009-0064196, filed on Jul. 14, 2009, in the Korean Intellectual Property Office, the disclosure of which is incorporated herein by reference.

### BACKGROUND OF THE INVENTION

1. Field of the Invention

The described technology relates to a rechargeable battery and battery case.

2. Description of the Related Art

The rechargeable battery that can be charged and discharge is used as a primary driving source of an electric vehicle (EV) or a hybrid electric vehicle (HEV). For example, the rechargeable battery is made of a structure in which an electrode assembly including a positive electrode, a separator, and a negative electrode penetrated with an electrolyte, is installed in a case.

The case may be formed as a metal can of a cylindrical shape or a prismatic shape, or may be formed with a laminate sheet including a resin sheet and a metal sheet. A rechargeable battery applied with the case made of the metal has excellent structural stability, and a rechargeable battery applied with the case made of the laminate sheet is light and the manufacturing process thereof is simple.

With the case formed with the laminate sheet, there is a difficulty to secure the sealing characteristic on the sealing interface of the laminate sheet. Also, there is a further difficulty to secure the sealing characteristic between the electrode terminal that protrudes outside of the case and is connected to the electrode assembly and the laminate sheet.

The above information disclosed in this Background section is only for enhancement of understanding of the background of the invention and therefore it may contain information that does not form the prior art that is already known in this country to a person of ordinary skill in the art.

### SUMMARY OF THE INVENTION

An aspect of the present invention may secure the sealing characteristic on a sealing interface of a laminate sheet forming a case.

An aspect of the present invention may secure the sealing characteristic on a sealing interface between the laminate sheet and an electrode terminal.

A rechargeable battery according to an aspect of the present invention includes: a case made of a laminate sheet; an electrode assembly installed in the case; and an electrode terminal that protrudes outside the case and is connected to the electrode assembly, wherein the case includes a receiving unit receiving the electrode assembly and including a first sealing part and a cover covering the receiving unit and including a second sealing part that is thermally fused to the first sealing part, the first sealing part and the second sealing part include first protrusions and depressions and second protrusions and depressions respectively formed on a portion corresponding at least to the electrode terminal, and the electrode terminal includes third protrusions and depressions respectively corresponding to the first protrusions and depressions and the second protrusions and depressions.

The first protrusions and depressions and the second protrusions and depressions may cross each other, thereby forming a combination structure.

The first protrusions and depressions and the second protrusions and depressions may be formed with a hexahedron shape at positions that are separated in the x direction and the y direction of an x-y plane. The first protrusions and depressions and the second protrusions and depressions may be formed with cross-sectional quadrangle ridges/furrows that are separated in the x direction of an x-y plane and are connected in the y direction.

The first protrusions and depressions and the second protrusions and depressions may be formed with hemispherical shapes at positions that are separated in the x direction and the y direction of an x-y plane.

The first protrusions and depressions and the second protrusions and depressions may be formed of cross-sectional semicircular ridges/furrows that are separated in the x direction of an x-y plane and is connected in the y direction.

The first protrusions and depressions and the second protrusions and depressions may be formed as triangular pyramids at positions that are separated in the x direction and the y direction of an x-y plane.

The first protrusions and depressions and the second protrusions and depressions may be formed with cross-sectional triangular ridges/furrows that are separated in the x direction of a x-y plane and is connected in the y direction.

The third protrusions and depressions may be combined with the first protrusions and depressions with a first surface and with the second protrusions and depressions with a second surface opposite to the first surface.

The first protrusions and depressions and the second protrusions and depressions may be only formed on a portion overlapping the electrode terminal.

The first protrusions and depressions and the second protrusions and depressions may only be formed on a part of a portion overlapping the electrode terminal.

The first protrusions and depressions and the second protrusions and depressions may only be formed on both ends of the x direction of an x-y plane among a portion overlapping the electrode terminal.

According to an aspect of the present invention, the first protrusions and depressions and the second protrusions and depressions that are respectively formed at the first sealing part of the receiving unit and the second sealing part of the cover are thermal fused to each other such that the sealing characteristic is secured on the sealing interface in the first sealing part and the second sealing part.

Also, the first protrusions and depressions and the second protrusions and depressions are formed on the portion corresponding to at least electrode terminal, and are thermal fused to the both side of the third protrusions and depressions formed on the electrode terminal such that the sealing characteristic is respectively ensured on the sealing interface between the first sealing part and the electrode terminal, and the sealing interface between the second sealing part and the electrode terminal.

A case for a rechargeable battery according to an aspect of the present invention in which a receiving unit that receives an electrode assembly of the rechargeable battery with an electrode terminal extending from the electrode assembly, said receiving unit including a first sealing part having a plurality of first protrusions and depressions, and a cover covering the receiving unit and including a second sealing part having a plurality of second protrusions and depressions formed on at least a portion of the electrode terminal, wherein the first sealing part is thermally fused to the second sealing part with the plurality of first protrusions and depressions interlocking with the plurality of second protrusions and depressions.

According to an aspect of the present invention, the plurality of first protrusions and depressions and the plurality of second protrusions and depressions may be formed with a hexahedron shape at positions that are separated in the x direction and the y direction of an x-y plane.

According to an aspect of the present invention, the plurality of first protrusions and depressions and the plurality of second protrusions and depressions may be formed with cross-sectional quadrangle ridges/furrows that are separated in the x direction of an x-y plane and are connected in the y direction.

According to an aspect of the present invention, the plurality of first protrusions and depressions, and the plurality of second protrusions and depressions may be formed with a hemispheric shapes at positions that are separated in the x direction and the y direction of an x-y plane.

According to an aspect of the present invention, the plurality of first protrusions and depressions and the plurality of second protrusions and depressions may be formed of cross-sectional semicircular ridges/furrows that are separated in the x direction of an x-y plane and are connected in the y direction.

According to an aspect of the present invention, the plurality of first protrusions and depressions and the plurality of second protrusions and depressions may be formed as triangular pyramids at positions that are separated in the x direction and the y direction of an x-y plane.

According to an aspect of the present invention, the plurality of first protrusions and depressions and the plurality of second protrusions and depressions may be formed with cross-sectional triangular ridges/furrows that are separated in the x direction of an x-y plane and are connected in the y direction.

According to an aspect of the present invention, the electrode terminal includes a plurality of third protrusions and depressions respectively that correspond to and interlock with the plurality of first protrusions and depressions and the plurality of second protrusions and depressions.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a perspective view of a rechargeable battery according to the first exemplary embodiment of the present invention.

FIG. 2 is a partial exploded perspective view of the rechargeable battery shown in FIG. 1.

FIG. 3 is a detailed cross-sectional view of the first sealing part and the second sealing part in a state before thermal fusion.

FIG. 4 is a cross-sectional view of a electrode terminal, the first sealing part, and the second sealing part after the thermal fusion.

FIG. 5 is a partial perspective view of the electrode terminal, the first sealing part, and the second sealing part after the thermal fusion in a rechargeable battery according to the second exemplary embodiment of the present invention.

FIG. 6 is cross-sectional view taken along the line VI-VI of FIG. 5.

FIG. 7 is a partial perspective view of the electrode terminal, the first sealing part, and the second sealing part after the thermal fusion in a rechargeable battery according to the third exemplary embodiment of the present invention.

FIG. 8 is cross-sectional view taken along the line VIII-VIII FIG. 7.

FIG. 9 is a partial perspective view of the electrode terminal, the first sealing part, and the second sealing part after the thermal fusion in a rechargeable battery according to the fourth exemplary embodiment of the present invention.

FIG. 10 is cross-sectional view taken along the line X-X of FIG. 9.

FIG. 11 is a partial perspective view of the electrode terminal, the first sealing part, and the second sealing part after the thermal fusion in a rechargeable battery according to the fifth exemplary embodiment of the present invention.

FIG. 12 is cross-sectional view taken along the line XII-XII of FIG. 11.

FIG. 13 is a partial perspective view of the electrode terminal, the first sealing part, and the second sealing part after the thermal fusion in a rechargeable battery according to the sixth exemplary embodiment of the present invention.

FIG. 14 is cross-sectional view taken along the line XIV-XIV of FIG. 13.

### DETAILED DESCRIPTION

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention. The drawings and description are to be regarded as illustrative in nature and not restrictive. Like reference numerals designate like elements throughout the specification.

Recognizing that sizes and thicknesses of constituent members shown in the accompanying drawings are arbitrarily given for better understanding and ease of description, the present invention is not limited to the illustrated sizes and thicknesses.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. Alternatively, when an element is referred to as being “directly on” another element, there are no intervening elements present.

In order to clarify the present invention, elements extrinsic to the description are omitted from the details of this description, and like reference numerals refer to like elements throughout the specification.

In several exemplary embodiments, constituent elements having the same configuration are representatively described in a first exemplary embodiment by using the same reference numeral and only constituent elements other than the constituent elements described in the first exemplary embodiment will be described in other embodiments.

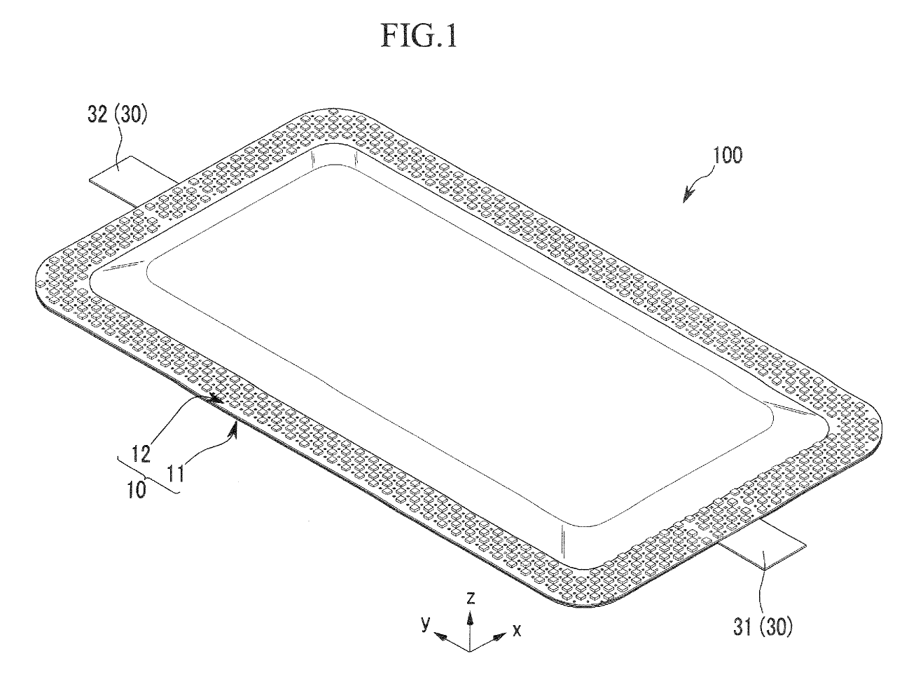

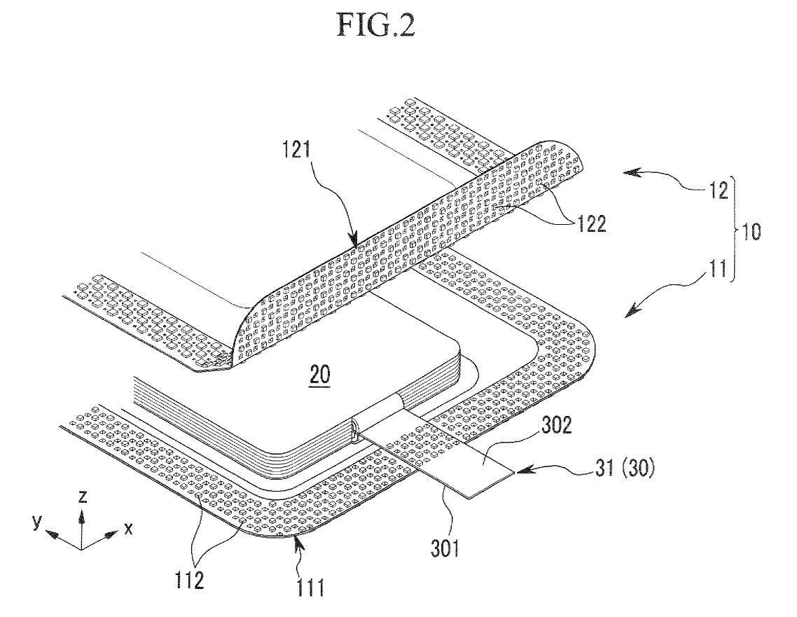

FIG. 1 is a perspective view of a rechargeable battery according to the first exemplary embodiment of the present invention, and FIG. 2 is a partial exploded perspective view of the rechargeable battery shown in FIG. 1. Referring to FIG. 1 and FIG. 2, the rechargeable battery 100 is referred to as “a pouch type rechargeable battery”. The pouch type rechargeable battery 100 includes a case 10 obtained by thermal fusion of a laminate sheet, an electrode assembly 20 installed in the case 10, and an electrode terminal 30 connected to the electrode assembly 20 and protruding outside of the case 10.

The electrode assembly 20 is made of a deposition structure of a positive electrode, a separator, and a negative electrode, or a jelly-roll shape formed by winding after the deposition, and is installed in the case 10 and impregnated with electrolyte inside the case 10. The electrode terminal 30 includes a positive electrode terminal 31 and a negative electrode terminal 32 respectively connected to the positive electrode and the negative electrode of the electrode assembly 20, and protrudes outside of the case 10. The positive electrode terminal 31 and the negative electrode terminal 32 may protrude out one side of the case 10 (not shown), as shown, or may protrude out both sides of the case 10.

The case 10 includes a receiving unit 11 and a cover 12 covering the receiving unit 11, and the electrode assembly 20 is received in an airtight space thereof that is formed by thermally fusing the receiving unit 11 and the cover 12. For the thermal fusion, the receiving unit 11 includes a first sealing part 111 having a predetermined width at the outer circumference thereof, and the cover 12 includes a second sealing part 121 having a predetermined width at the outer circumference thereof to be thermally fused with the first sealing part 111.

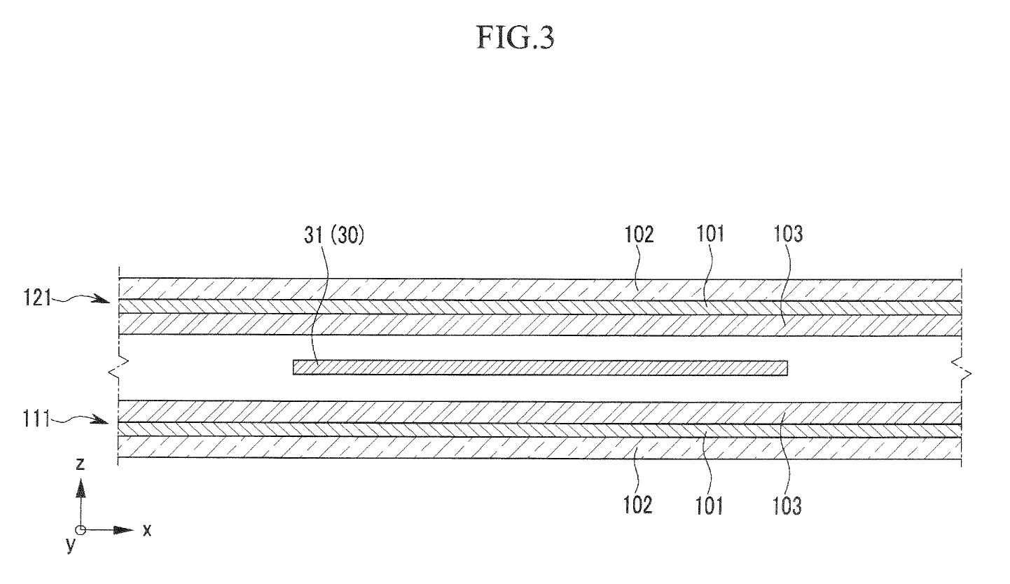

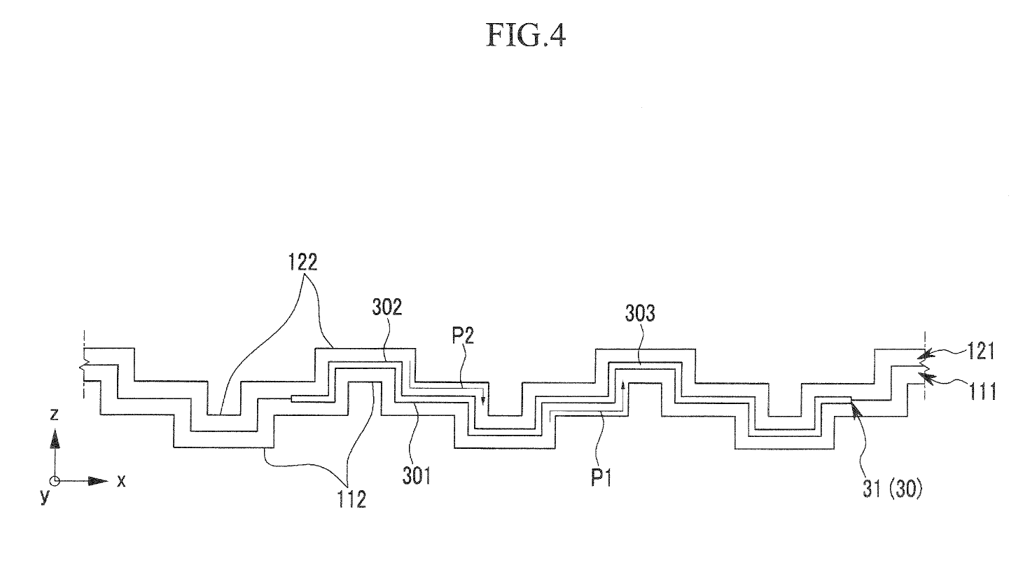

FIG. 3 is a detailed cross-sectional view of the first sealing part and the second sealing part in a state before thermal fusion, and FIG. 4 is a cross-sectional view of an electrode terminal, the first sealing part, and the second sealing part after the thermal fusion. Referring to FIG. 3 and FIG. 4, the receiving unit 11 and the cover 12 forming the case and the first and second sealing parts 111 and 121 extended therefrom are made of a laminate sheet.

The laminate sheet, that is, the receiving unit 11 and the cover 12, respectively include a metal sheet layer 101, an outer coating layer 102 formed on the outer surface of the metal sheet layer 101, and an inner coating layer 103 formed on the inner surface of the metal sheet layer 101.

The electrode assembly 20 is received in the receiving unit 11, the cover 12 covers it in a state in which the electrode terminal 30 protrudes therefrom, and then the first sealing part 111 of the receiving unit 11 and the second sealing part 121 of the cover 12 are thermal fused by using a heat bar (not shown) provided on the outer surface of the first sealing part 111 and the second sealing part 121, thereby completing the case 10.

That is, in the state of FIG. 3, the heat bars are disposed on the lower side of the first sealing part 111 of the receiving unit 11 and the upper side of the second sealing part 121 of the cover 12, and the first sealing part 111 and the second sealing part 121 are thermally fused according to the surface shape of the heat bars such that they may have various shapes.

Under the thermal fusion, the first sealing part 111 and the second sealing part 121 are combined to each other while forming first protrusions and depressions 112 and second protrusions and depressions 122 facing away from each other (referring to FIG. 4). The first protrusions and depressions 112 and the second protrusions and depressions 122 are at least formed at a portion corresponding to an electrode terminal 30, and the present exemplary embodiment shows a configuration in which the first protrusions and depressions 112 and the second protrusions and depressions 122 correspond to the entire range of the first and second sealing parts 111 and 121.

That is, the first protrusions and depressions 112 and the second protrusions and depressions 122 may be formed at a portion overlapping the electrode terminal 30, and may have the same operation as the case in which they are formed on the entire range of the first and second sealing parts 111 and 121.

The first protrusions and depressions 112 and the second protrusions and depressions 122 may be formed on the entire portion overlapping the electrode terminal 30, and on a part of the overlapping portion. In this way, when the first protrusions and depressions 112 and the second protrusions and depressions 122 are formed on a part of the portion overlapping the electrode terminal 30, disconnection of the electrode terminal 30 that may be generated by the first protrusions and depressions 112 and the second protrusions and depressions 122 can be effectively prevented.

In detail, the first protrusions and depressions 112 and the second protrusions and depressions 122 may be partially formed on both ends of an x direction on an x-y plane among the portion overlapping the electrode terminal 30. In this case, the generation possibility of the disconnection of the electrode terminal 30 is reduced, and the sealing characteristic that may be weak on both ends of the x direction of the electrode terminal 30 can be enhanced.

By the thermal fusion pressure of the heat bar, the electrode terminal 30 forms third protrusions and depressions 303 corresponding to the first protrusions and depressions 112 and the second protrusions and depressions 122. That is, the third protrusions and depressions 303 formed at the electrode terminal 30 are combined to the first protrusions and depressions 112 with a first surface 301, and are combined to the second protrusions and depressions 122 with a second surface 302.

That is, the first sealing part 111 of the receiving unit 11 and the electrode terminal 30 is combined to the first protrusions and depressions 112 with the first surface 301 of the third protrusions and depressions 303 such that the mutual adhesion area is increased, and a first path P1 formed against the penetration of the moisture is elongated. Also, the second sealing part 121 of the cover 12 and the electrode terminal 30 is combined to the second protrusions and depressions 122 with the second surface 302 of the third protrusions and depressions 303 such that the mutual adhesion area is increased, and the second path P2 formed under the penetration of the moisture is elongated.

Again, referring to FIG. 2 and FIG. 4, the first protrusions and depressions 112 and the second protrusions and depressions 122 are respectively formed with a hexahedron shape, and are independently disposed at positions that are separated in the x direction and the y direction on the x-y plane.

That is, when the first protrusions and depressions 112 form the hexahedron shape protruding toward the second protrusions and depressions 122, the second protrusions and depressions 122 that are combined face-to-face thereto form a concave space of the hexahedron shape to receive the hexahedron structure of the first protrusions and depressions 112. When the second protrusions and depressions 122 form the hexahedron shape protruding toward the first protrusions and depressions 112, the first protrusions and depressions 112 that are combined face-to-face thereto form a concave space of the hexahedron structure to receive the hexahedron structure of the second protrusions and depressions 122.

The first protrusions and depressions 112 are independently disposed along the x direction and the y direction, the second protrusions and depressions 122 are independently disposed along the x direction and the y direction, and the first protrusions and depressions 112 and the second protrusions and depressions 122 are thermally fused with the combination structure to each other. Accordingly, the first and second paths P1 and P2 may be increased in the x direction and y direction. The combination strength of the first and second sealing parts 111 and 121 may be enhanced at four corners of the case 10.

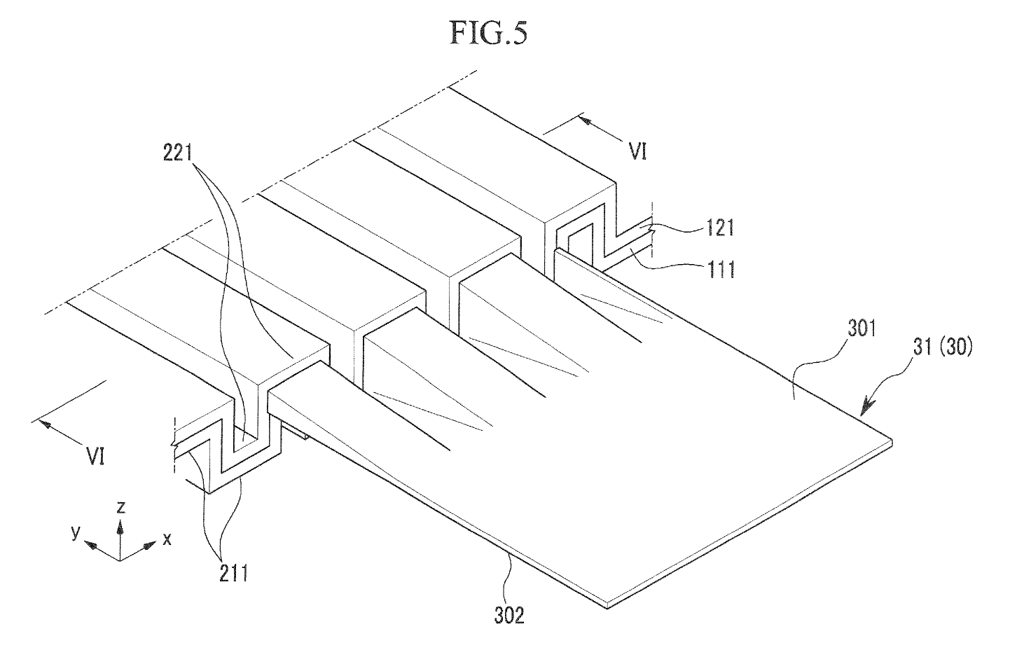

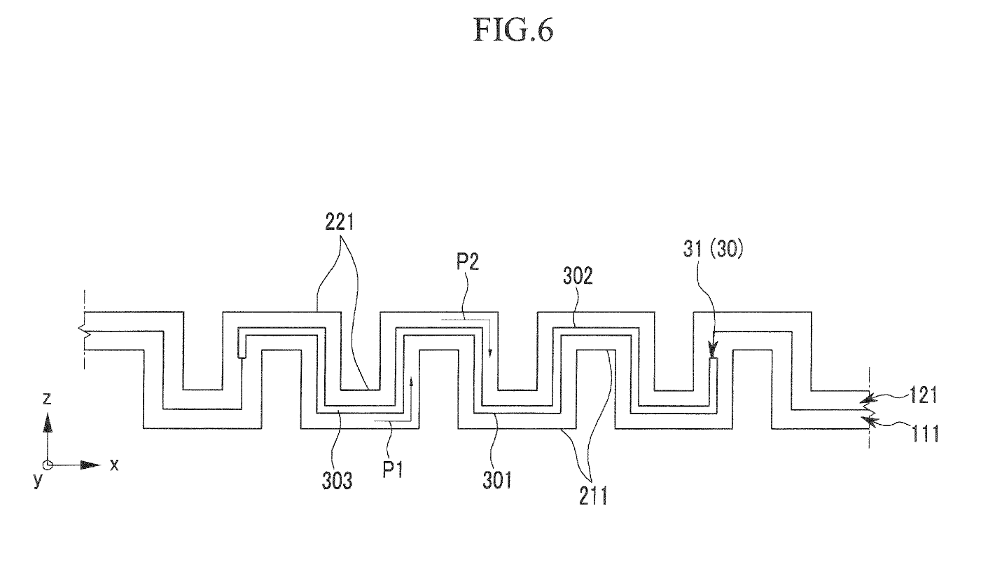

FIG. 5 is a partial perspective view of the electrode terminal, the first sealing part, and the second sealing part after the thermal fusion in a rechargeable battery according to the second exemplary embodiment of the present invention, and FIG. 6 is cross-sectional view taken along the line VI-VI of FIG. 5.

The first and second protrusions and depressions 112 and 122 of the first exemplary embodiment are independently disposed at the positions that are separated in the x direction and the y direction on the x-y plane of the first and second sealing parts 111 and 121. However, the first and second protrusions and depressions 211 and 221 of the second exemplary embodiment are repeatedly disposed in the x direction on the x-y plane of the first and second sealing parts 111 and 121, and are formed in a quadrangle ridge/furrow cross-sectional shape in the y direction. Accordingly, the first and second paths P1 and P2 are increased in the x direction.

The first protrusions and depressions 211 and the second protrusions and depressions 221 are formed with the cross-sectional quadrangle ridges/furrows that are connected to each other, repeatedly disposed on the x-y plane, and continue in the y direction.

That is, when the first protrusions and depressions 211 form convex cross-sectional quadrangle ridges/furrows protruding toward the second protrusions and depressions 221, the second protrusions and depressions 221 that are combined and face thereto form concave spaces of the cross-sectional quadrangle ridges/furrows to receive the convex parts of the cross-sectional quadrangle ridges/furrows of the first protrusions and depressions 211. Also, when the second protrusions and depressions 221 form the convex cross-sectional quadrangle ridges/furrows protruding toward the first protrusions and depressions 211, the first protrusions and depressions 211 that are combined and face thereto form a concave space of the cross-sectional quadrangle ridges/furrows to receive the convex the cross-sectional quadrangle ridges/furrows of the second protrusions and depressions 221.

The first and second protrusions and depressions 211 and 221 are repeatedly formed in the x direction and are connected in the y direction and thereby they are thermally fused in the combination structure to each other. That is, the first sealing part 111 of the receiving unit 11 and the electrode terminal 30 are combined to the first protrusions and depressions 211 with the first surface 301 of the third protrusions and depressions 303 such that the mutual adhesion area is increased, and the first path P1 is elongated. Also, the second sealing part 121 of the cover 12 and the electrode terminal 30 are combined to the second protrusions and depressions 221 with the second surface 302 of the third protrusions and depressions 303 such that the mutual adhesion area is increased, and the second path P2 is elongated.

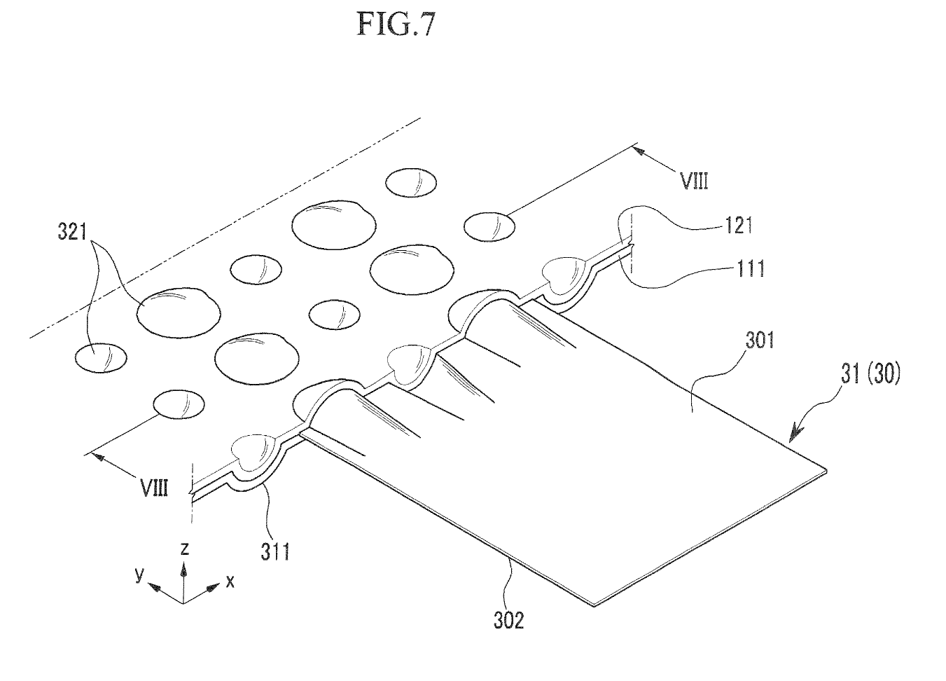

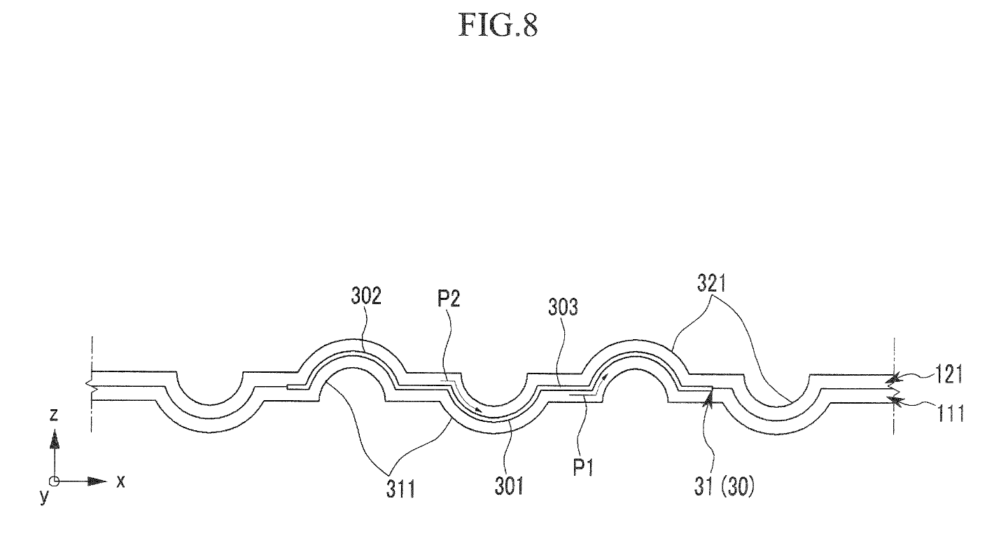

FIG. 7 is a partial perspective view of the electrode terminal, the first sealing part, and the second sealing part after the thermal fusion in a rechargeable battery according to the third exemplary embodiment of the present invention, and FIG. 8 is cross-sectional view taken along the line VIII-VIII FIG. 7.

The first and second protrusions and depressions 112 and 122 of the first exemplary embodiment are formed of the hexahedron shape and are independently disposed at positions that are separated in the x direction and the y direction on the x-y plane. However, the first and second protrusions and depressions 311 and 321 of the third exemplary embodiment are formed of a hemispherical shape that are independently disposed at positions that are separated in the x direction and the y direction on the x-y plane. Accordingly, compared with the first and second paths P1 and P2 that are formed at right angles in the first exemplary embodiment, the first and second paths P1 and P2 are formed with curved lines in the third exemplary embodiment.

That is, when the first protrusions and depressions 311 form the hemispheric shapes protruding toward the second protrusions and depressions 321, the second protrusions and depressions 321 that are combined and face thereto form a concave space of the hemispheric shapes to receive the hemispheric shapes of the first protrusions and depressions 311. Also, when the second protrusions and depressions 321 form the hemispheric shapes protruding toward the first protrusions and depressions 311, the first protrusions and depressions 311 that are combined and face thereto form concave spaces of the hemispheric shapes to receive the hemispheric shapes of the second protrusions and depressions 321.

The first protrusions and depressions 311 are independently disposed at positions that are separated in the x direction and the y direction, the second protrusions and depressions 321 are independently disposed at positions that are separated in the x direction and the y direction, and the first protrusions and depressions 311 and the second protrusions and depressions 321 are thermal fused in the combination structure with each other. Accordingly, the first and second paths P1 and P2 may be respectively elongated in the x direction and the y direction.

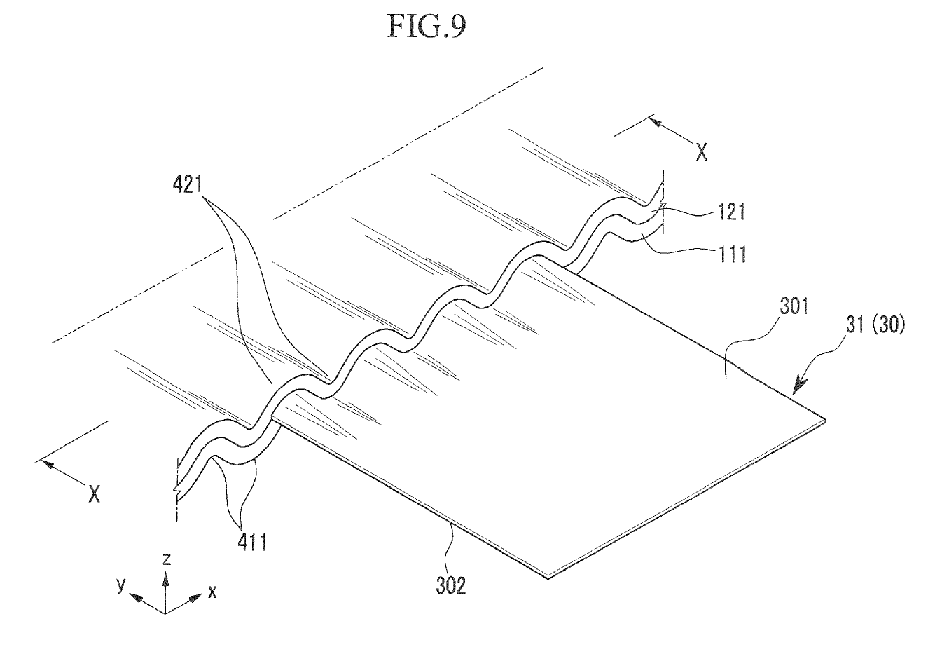

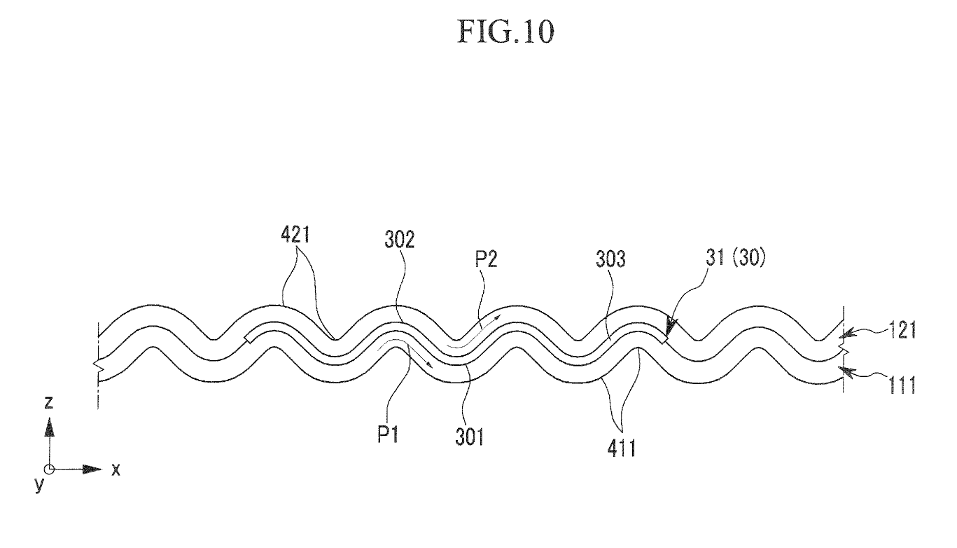

FIG. 9 is a partial perspective view of the electrode terminal, the first sealing part and the second sealing part after the thermal fusion in a rechargeable battery according to the fourth exemplary embodiment of the present invention, and FIG. 10 is cross-sectional view taken along the line X-X of FIG. 9.

The first and second protrusions and depressions 311 and 321 of the third exemplary embodiment are independently disposed at positions that are separated in the x direction and the y direction on the x-y plane. However, the first and second protrusions and depressions 411 and 421 of the fourth exemplary embodiment is formed of cross-sectional semicircular ridges/furrows that are separated in the x direction and are connected in the y direction on the x-y plane. Accordingly, the first and second paths P1 and P2 are formed as curved lines.

The first protrusions and depressions 411 and the second protrusions and depressions 421 are cross-sectional semicircular ridges/furrows that are connected to each other, and are repeatedly disposed in the x direction and are continuous in the y direction on the x-y plane.

That is, when the first protrusions and depressions 411 form the convex parts of the cross-sectional semicircular ridges/furrows protruding toward the second protrusions and depressions 421, the second protrusions and depressions 421 that are combined and face thereto form the concave space of the cross-sectional semicircular ridge/furrow to receive the convex parts of the cross-sectional semicircular ridges/furrows of the first protrusions and depressions 411. Also, when the second protrusions and depressions 421 form the convex parts of the cross-sectional semicircular ridge/furrow protruding toward the first protrusions and depressions 411, the first protrusions and depressions 411 that are combined and face thereto form the concave space of the cross-sectional semicircular ridges/furrows to receive the convex parts of the cross-sectional semicircular ridges/furrows of the second protrusions and depressions 421.

The first and second protrusions and depressions 411 and 421 are repeated in the x direction and are connected in the y direction, such that they are thermally fused in the combination structure to each other. That is, the first sealing part 111 of the receiving unit 11 and the electrode terminal 30 is combined to the first protrusions and depressions 411 with the first surface 301 of the third protrusions and depressions 303, such that the mutual adhesion area is increased and the first path P1 is elongated. Also, the second sealing part 121 of the cover 12 and the electrode terminal 30 is combined to the second protrusions and depressions 421 with the second surface 302 of the third protrusions and depressions 303, such that the mutual adhesion area is increased and the second path P2 is elongated.

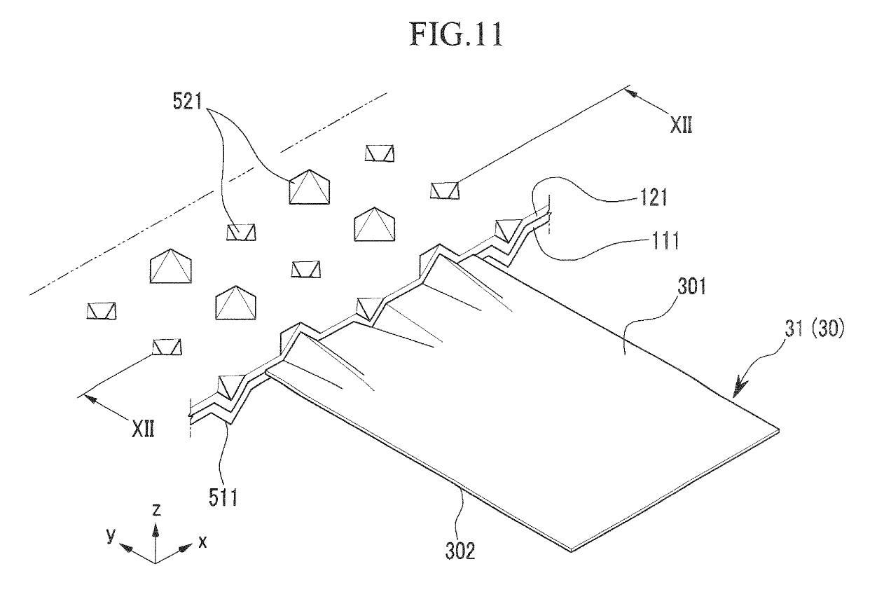

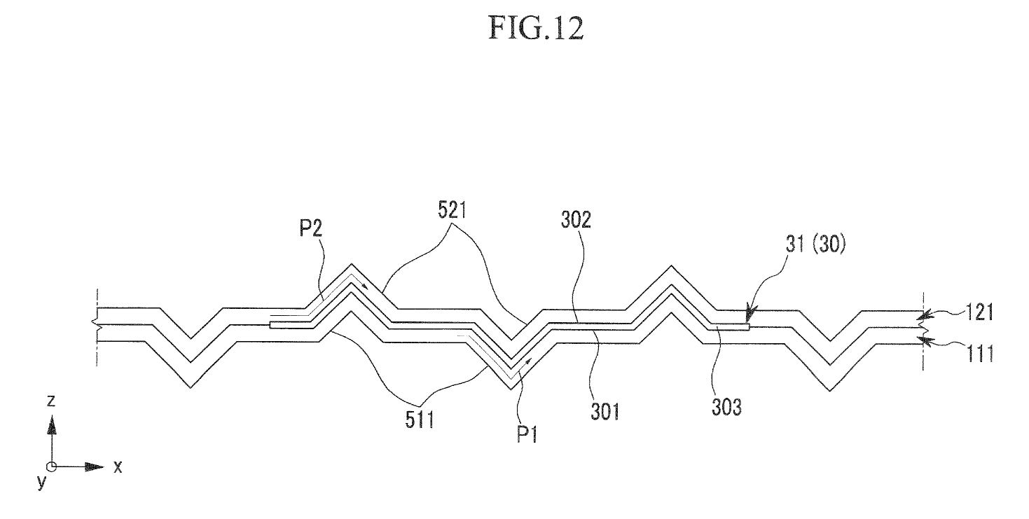

FIG. 11 is a partial perspective view of the electrode terminal, the first sealing part, and the second sealing part after the thermal fusion in a rechargeable battery according to the fifth exemplary embodiment of the present invention, and FIG. 12 is cross-sectional view taken along the line XII-XII of FIG. 11.

The first and second protrusions and depressions 311 and 321 of the third exemplary embodiment are formed with the hemispheric shapes that are independently disposed at positions that are separated in the x direction and the y direction of the x-y plane. However, the first and second protrusions and depressions 511 and 521 of the fifth exemplary embodiment are formed with triangular pyramidal shapes and are independently disposed at positions that are separated in the x direction and the y direction of the x-y plane. Accordingly, compared with the third exemplary embodiment forming the first and second paths P1 and P2 of a curved line, the first and second paths P1 and P2 of the fifth exemplary embodiment are formed with angles.

That is, the first protrusions and depressions 511 form the triangular pyramidal shapes that protrude toward the second protrusions and depressions 521, and the second protrusions and depressions 521 that are combined and face thereto forms the concave space of the triangular pyramidal shapes to receive the triangular pyramidal shapes of the first protrusions and depressions 511. Also, the second protrusions and depressions 521 form the triangular pyramidal shapes that protrude toward the first protrusions and depressions 511, and the first protrusions and depressions 511 that are combined and face thereto form the concave space of the triangular pyramidal shapes to receive the triangular pyramidal shapes of the second protrusions and depressions 521.

The first protrusions and depressions 511 are independently disposed at positions that are separated in the x direction and the y direction, the second protrusions and depressions 521 are independently disposed at positions that are separated in the x direction and the y direction, and the first protrusions and depressions 511 and the second protrusions and depressions 521 are thermally fused in the combination structure to each other. Accordingly, the first and second paths P1 and P2 are respectively increased in the x direction and the y direction.

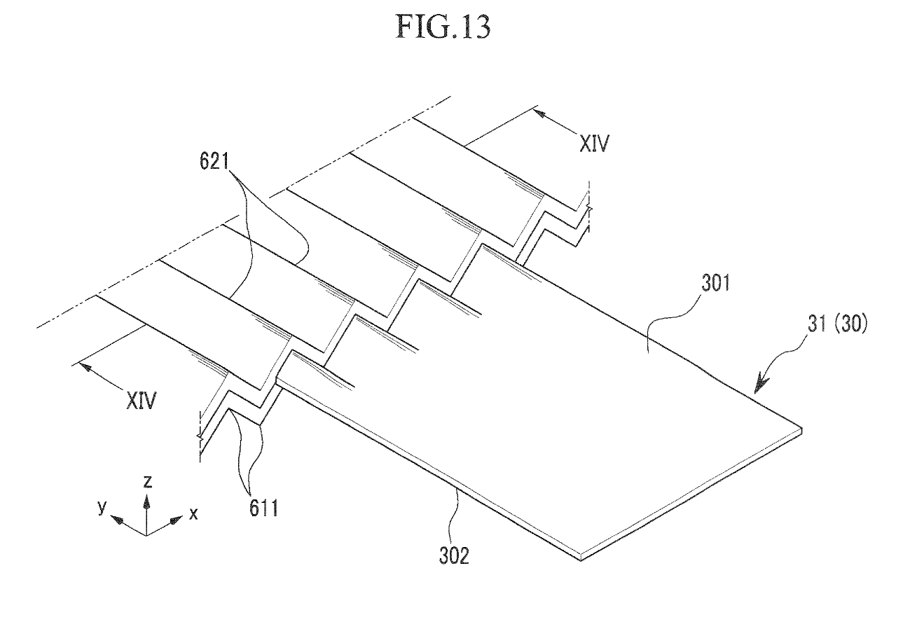

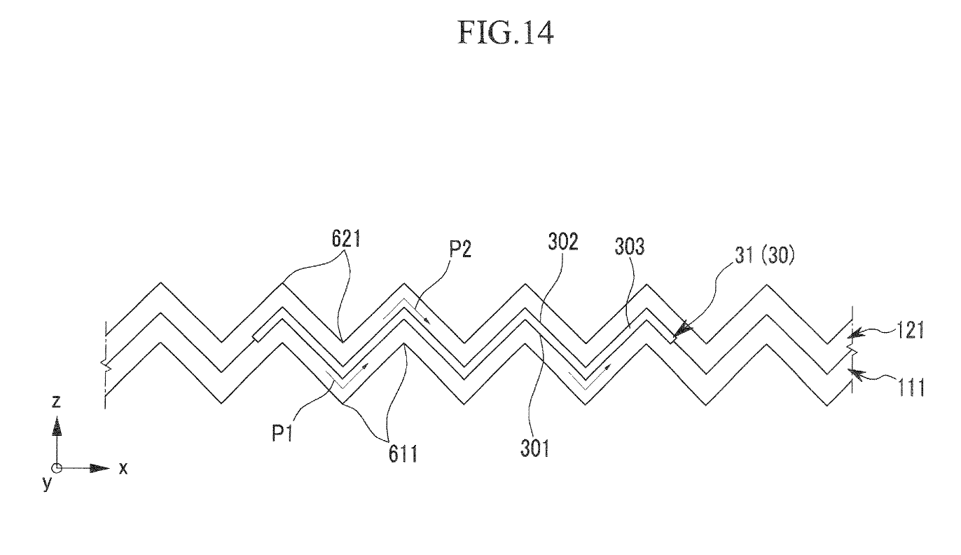

FIG. 13 is a partial perspective view of the electrode terminal, the first sealing part, and the second sealing part after the thermal fusion in a rechargeable battery according to the sixth exemplary embodiment of the present invention, and FIG. 14 is cross-sectional view taken along the line XIV-XIV of FIG. 13.

The first and second protrusions and depressions 511 and 521 of the fifth exemplary embodiment are independently disposed at positions that are separated in the x direction and the y direction of the x-y plane. However, the first and second protrusions and depressions 611 and 621 of the sixth exemplary embodiment are formed as cross-sectional triangular ridges/furrows that are separated in x direction of the x-y plane, and are connected in the y direction. Accordingly, the first and second paths P1 and P2 are formed with a curved line.

The first protrusions and depressions 611 and the second protrusions and depressions 621 are formed of cross-sectional triangular ridges/furrows that are combined to each other, are repeated in the x direction of the x-y plane, and are connected in the y direction.

That is, when the first protrusions and depressions 611 form the convex parts cross-sectional triangular ridges/furrows toward the second protrusions and depressions 621, the second protrusions and depressions 621 that are combined and face thereto form the concave cross-sectional triangular ridges/furrows to receive the convex parts of the cross-sectional triangle ridges/furrows of the first protrusions and depressions 611. Also, when the second protrusions and depressions 621 form the convex parts of the cross-sectional triangular ridges/furrows toward the first protrusions and depressions 611, the first protrusions and depressions 611 that are combined and face thereto form the concave parts of the cross-sectional triangular ridges/furrows to receive the convex parts of the cross-sectional triangular ridges/furrows of the second protrusions and depressions 621.

The first and second protrusions and depressions 611 and 621 are repeated in the x direction, and are connected in the y direction thereby being thermal fused. That is, the first sealing part 111 of the receiving unit 11 and the electrode terminal 30 is combined to the first protrusions and depressions 611 with the first surface 301 of the third protrusions and depressions 303 such that the mutual adhesion area is increased, and the first path P1 is elongated. Also, the second sealing part 121 of the cover 12 and the electrode terminal 30 is combined to the second protrusions and depressions 621 with the second surface 302 of the third protrusions and depressions 303 such that the mutual adhesion area is increased, and the second path P2 is elongated.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A rechargeable battery, comprising:
a case made of a laminate sheet;
an electrode assembly installed in the case; and
an electrode terminal that protrudes outside the case and is connected to the electrode assembly,
wherein the case includes
a receiving unit receiving the electrode assembly and including a first sealing part, and
a cover covering the receiving unit and including a second sealing part that is thermally fused to the first sealing part,
the first sealing part and the second sealing part include first protrusions and depressions and second protrusions and depressions respectively formed on a portion corresponding at least to the electrode terminal, and
the electrode terminal includes third protrusions and depressions respectively corresponding to the first protrusions and depressions and the second protrusions and depressions.

2. The rechargeable battery of claim 1, wherein
the first protrusions and depressions and the second protrusions and depressions cross each other, thereby forming a combination structure.

3. The rechargeable battery of claim 1, wherein
the first protrusions and depressions and the second protrusions and depressions are formed with a hexahedron shape at positions that are separated in the x direction and the y direction of an x-y plane.

4. The rechargeable battery of claim 1, wherein
the first protrusions and depressions and the second protrusions and depressions are formed with cross-sectional quadrangle ridges/furrows that are separated in the x direction of an x-y plane and are connected in the y direction.

5. The rechargeable battery of claim 1, wherein:
the first protrusions and depressions, and the second protrusions and depressions are formed with a hemispheric shapes at positions that are separated in the x direction and the y direction of an x-y plane.

6. The rechargeable battery of claim 1, wherein
the first protrusions and depressions and the second protrusions and depressions are formed of cross-sectional semicircular ridges/furrows that are separated in the x direction of an x-y plane and are connected in the y direction.

7. The rechargeable battery of claim 1, wherein
the first protrusions and depressions and the second protrusions and depressions are formed as triangular pyramids at positions that are separated in the x direction and the y direction of an x-y plane.

8. The rechargeable battery of claim 1, wherein
the first protrusions and depressions and the second protrusions and depressions are formed with cross-sectional triangular ridges/furrows that are separated in the x direction of an x-y plane and are connected in the y direction.

9. The rechargeable battery of claim 1, wherein
the third protrusions and depressions are combined with
the first protrusions and depressions with a first surface and
with the second protrusions and depressions with a second surface opposite to the first surface.

10. The rechargeable battery of claim 1, wherein
the first protrusions and depressions and the second protrusions and depressions are only formed on a portion overlapping the electrode terminal.

11. The rechargeable battery of claim 1, wherein
the first protrusions and depressions and the second protrusions and depressions are only formed on a part of a portion overlapping the electrode terminal.

12. The rechargeable battery of claim 11, wherein
the first protrusions and depressions and the second protrusions and depressions are only formed on both ends of the x direction of an x-y plane among a portion overlapping the electrode terminal.

13. A case for a rechargeable battery, comprising:
a receiving unit that receives an electrode assembly of the rechargeable battery with an electrode terminal extending from the electrode assembly, said receiving unit including a first sealing part having a plurality of first protrusions and depressions, and
a cover covering the receiving unit and including a second sealing part having a plurality of second protrusions and depressions formed on at least a portion of the electrode terminal,
wherein the first sealing part is thermally fused to the second sealing part with the plurality of first protrusions and depressions interlocking with the plurality of second protrusions and depressions.

14. The case recited in claim 13, wherein
the plurality of first protrusions and depressions and the plurality of second protrusions and depressions are formed with a hexahedron shape at positions that are separated in the x direction and the y direction of an x-y plane.

15. The case recited in claim 13, wherein
the plurality of first protrusions and depressions and the plurality of second protrusions and depressions are formed with cross-sectional quadrangle ridges/furrows that are separated in the x direction of an x-y plane and are connected in the y direction.

16. The case recited in claim 13, wherein:
the plurality of first protrusions and depressions, and the plurality of second protrusions and depressions are formed with a hemispheric shapes at positions that are separated in the x direction and the y direction of an x-y plane.

17. The case recited in claim 13, wherein
the plurality of first protrusions and depressions and the plurality of second protrusions and depressions are formed of cross-sectional semicircular ridges/furrows that are separated in the x direction of an x-y plane and are connected in the y direction.

18. The case recited in claim 13, wherein
the plurality of first protrusions and depressions and the plurality of second protrusions and depressions are formed as triangular pyramids at positions that are separated in the x direction and the y direction of an x-y plane.

19. The case recited in claim 13, wherein
the plurality of first protrusions and depressions and the plurality of second protrusions and depressions are formed with cross-sectional triangular ridges/furrows that are separated in the x direction of an x-y plane and are connected in the y direction.

20. The case recited in claim 13, wherein
the electrode terminal includes a plurality of third protrusions and depressions respectively that correspond to and interlock with the plurality of first protrusions and depressions and the plurality of second protrusions and depressions.
